(19) United States
(12) Patent Application Publication
(10) Pub. No.: US 2020/0054158 A1
(43) Pub. Date: Feb. 20, 2020

(54) MULTIPURPOSE TRAY APPARATUS AND SYSTEM INCLUDING THE SAME

(71) Applicant: Junhyeok OH, Seoul (KR)

(72) Inventor: Junhyeok OH, Seoul (KR)

(21) Appl. No.: 16/105,724

(22) Filed: Aug. 20, 2018

(51) Int. Cl. A47G 23/06; H02J 7/02

(52) U.S. Cl. CPC A47G 23/0683; H02J 7/025

(57) ABSTRACT

The present invention relates to a multipurpose tray apparatus and a system including the same, and more particularly, to a multipurpose tray apparatus and a system including the same which provides additional functions such as charging of terminals or warming of beverages by an electronic device module constituted therein while mounting and fixing a beverage container. According to the exemplary embodiment of the present invention, the multipurpose tray apparatus can be not only used as a tray for mounting and carrying beverages but also used as various uses such as charging of terminals or warming of beverages mounted on the multipurpose tray apparatus to ensure versatility through use extension as compared with existing trays limited to be used for mounting and carrying the beverage container, thereby enhancing the convenience of the user.

### BACKGROUND OF THE INVENTION

### Field of the Invention

The present invention relates to a multipurpose tray apparatus and a system including the same, and more particularly, to a multipurpose tray apparatus and a system including the same which provides additional functions such as charging of terminals or warming of beverages by an electronic device module constituted therein while mounting and fixing a beverage container.

### Description of the Related Art

A store for selling beverages provides a tray for a purchaser who has purchased the beverage to carry a container containing the beverage.

However, there is a problem that a conventional tray is used only for simply mounting and carrying the beverage container, and thus the efficiency is extremely low.

### SUMMARY OF THE INVENTION

An object of the present invention is to provide a multipurpose tray apparatus which provides additional functions such as warming of beverages or wireless charging of terminals by an electronic device module constituted therein while supporting a beverage container to be mounted and fixed.

Another object of the present invention is to provide a multipurpose tray system capable of providing esthetics by patterning a configuration for stacking and charging in a multipurpose tray apparatus while easily storing and using later the multipurpose tray apparatus by supporting a plurality of multipurpose tray apparatuses to be charged while stacking and fixing the plurality of multipurpose tray apparatuses.

An exemplary embodiment of the present invention provides a multipurpose tray system which includes a charging station supplying charging power and a multipurpose tray apparatus stacked on the charging station to be stored and charged, in which the multipurpose tray apparatus may include a body having a beverage container mounted on an upper surface thereof; a plurality of protruding structures protruding from the upper surface of the body to fixedly support the beverage container, separated into at least two or more, and having an electrode formed on at least one side; a battery configured in the body to supply electric power to the electrode; an electronic device module configured in the body to operate based on the electric power supplied from the battery; and a plurality of grooves which is formed on the lower of the body, has a shape corresponding to each of the plurality of protruding structures, and has a charge electrode corresponding to the electrode.

In one embodiment related to the present invention, the body may have a regular polygonal or circular shape.

In one embodiment related to the present invention, each of the plurality of protruding structures may have an inclined portion formed at one side to discharge water droplets of the beverage container so as not to contact the electrode when the water droplets of the beverage container flow down.

In one embodiment related to the present invention, the electrode may be formed on a part of the upper surface of the protruding structures.

In one embodiment related to the present invention, the electronic device module may be configured as a heater for heating the beverage container so that the beverage of the beverage container mounted on the upper surface of the body is maintained at a predetermined temperature.

In one embodiment related to the present invention, the electronic device module may be configured by a wireless charging module that provides charging power to the communication device mounted on the upper surface of the body in a wireless charging manner based on the electric power supplied from the battery.

In one embodiment related to the present invention, the charging station may include a case, a plurality of fixing structures which protrude from an upper surface of the case to correspond to the plurality of grooves formed on the body, respectively, to be received into the grooves of the body when the body of the multipurpose tray apparatus is stacked on the upper surface of the case and are connected to the charging electrode of the grooves so that the charging terminal providing the charging power to the charging electrode is configured on a part of the upper surface, and a power control module which provides the charging power to the charging electrode configured in the grooves of the body through the charging terminal based on commercial power provided from the external power source to charge the battery of the multipurpose tray apparatus connected with the charging electrode.

In one embodiment related to the present invention, a plurality of grooves corresponding to the plurality of protruding structures may be formed on a lower surface of the multipurpose tray apparatus to be duplicated to each of the plurality of different regions on the lower surface, so that the multipurpose tray apparatus is rotated in an arbitrary direction to be disposed on the upper surface of the body of the case of the charging station or the other multipurpose tray apparatus.

In one embodiment related to the present invention, the protruding structure may have an elliptical shape.

Another exemplary embodiment of the present invention provides a multipurpose tray apparatus including: a body having a beverage container mounted on an upper surface thereof, a plurality of protruding structures protruding from the upper surface of the body to fixedly support the beverage container, separated into at least two or more, and having an electrode formed on at least one side, a battery configured in the body to supply electric power to the electrode, an electronic device module configured in the body to operate based on the electric power supplied from the battery, and a plurality of grooves which are formed on the lower surface of the body, has a shape corresponding to each of the plurality of protruding structures, and has a charge electrode corresponding to the electrode.

According to the exemplary embodiment of the present invention, the multipurpose tray apparatus can be not only used as a tray for mounting and carrying beverages but also used as various uses such as charging of terminals or warming of beverages mounted on the multipurpose tray apparatus to ensure versatility through use extension as compared with existing trays limited to be used for mounting and carrying the beverage container, thereby enhancing the convenience of the user.

Further, the multipurpose tray system according to the exemplary embodiment of the present invention provides a charging station capable of stacking and charging the multipurpose tray apparatuses to support the multipurpose tray apparatus to be stacked and stored in any arrangement state while supporting the multipurpose tray apparatuses to be easily charged and stored, thereby increasing the storage convenience.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view of a multipurpose tray apparatus according to an exemplary embodiment of the present invention;

FIG. 2 is a use state view of the multipurpose tray apparatus according to the exemplary embodiment of the present invention;

FIG. 3 is a plan view of the multipurpose tray apparatus according to the exemplary embodiment of the present invention;

FIG. 4 is a block view of the multipurpose tray apparatus according to the exemplary embodiment of the present invention;

FIG. 5 is a bottom view of the multipurpose tray apparatus according to the exemplary embodiment of the present invention;

FIG. 6 is a perspective view of a multipurpose tray apparatus and a charge station constituting a multipurpose tray system according to an exemplary embodiment of the present invention; and

FIG. 7 is a bottom view of a multipurpose tray apparatus according to another exemplary embodiment of the present invention.

### DETAILED DESCRIPTION OF THE PREFERRED EMBODIMENT

Hereinafter, detailed exemplary embodiments of the present invention will be described with reference to the accompanying drawings.

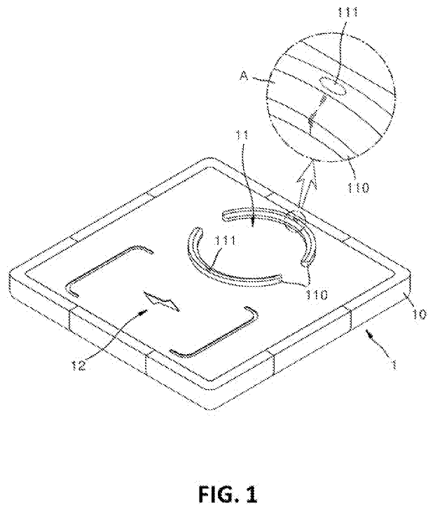

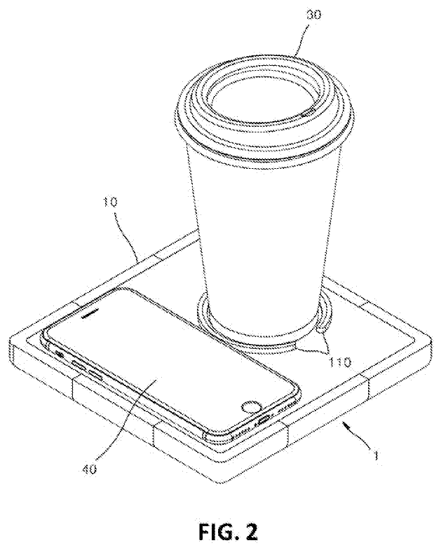

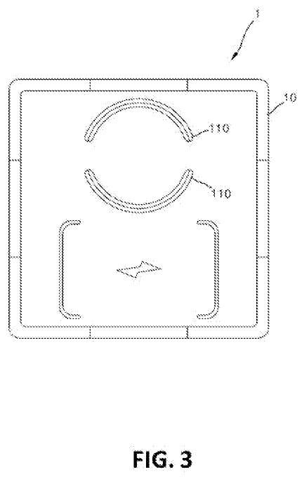

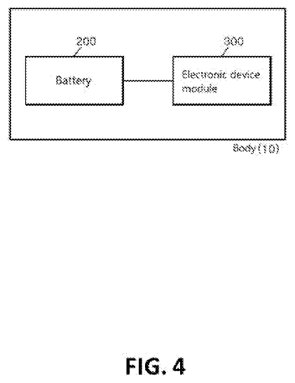

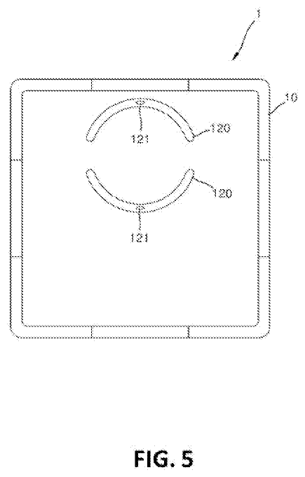

FIG. 1 is a perspective view of a multipurpose tray apparatus according to an exemplary embodiment of the present invention, FIG. 2 is a use state view of the multipurpose tray apparatus according to the exemplary embodiment of the present invention, FIG. 3 is a plan view of the multipurpose tray apparatus according to the exemplary embodiment of the present invention, FIG. 4 is a block view of the multipurpose tray apparatus according to the exemplary embodiment of the present invention, and FIG. 5 is a bottom view of the multipurpose tray apparatus according to the exemplary embodiment of the present invention.

First, as shown in FIGS. 1 to 3, the multipurpose tray apparatus 1 may include a body 10 having a beverage container 30 mounted on an upper surface thereof, and a plurality of protruding structures 110 protruding from the upper surface of the body 10 to fixedly support the beverage container 30, separated into at least two or more, and having an electrode 111 formed on at least one side.

As shown in FIG. 4, the multipurpose tray apparatus 1 may include a battery 200 configured in the body 10 to supply electric power to the electrode 111, and an electronic device module 300 configured in the body 10 to operate based on the electric power supplied from the battery 200.

As shown in FIG. 5, the multipurpose tray apparatus 1 may include a plurality of grooves 120 which is formed on the lower surface (or the bottom surface) of the body 10, has a shape corresponding to each of the plurality of protruding structures 110, and has a charge electrode 121 corresponding to the electrode 111.

At this time, the body 10 may have a regular polygonal or circular shape.

Further, the protruding structure 110 may be formed in an elliptical shape to fix and support the beverage container 30 in correspondence with the shape of the lower end of the beverage container 30 and configured to face the lower end portion of the beverage container 30.

Accordingly, the beverage container 30, which is seated in a partial region of the body 10 having the plurality of protruding structures 110, may be fixed by the protruding structures 110.

Further, as shown in FIG. 1, each of the plurality of protruding structures 110 may have an inclined portion A formed at one side to discharge water droplets of the beverage container 30 so as not to contact the electrode 111 when the water droplets of the beverage container 30 flow down.

In addition, the electrode 111 may be formed on a part of the upper surface of the protruding structures 110.

Meanwhile, the electronic device module 300 may be configured by a wireless charging module that provides charging power to the terminal 40 mounted on the upper surface of the body 10 in a wireless charging manner based on the electric power supplied from the battery 200.

As an example, as shown in FIGS. 1 to 3, the body 10 may include a first region 11 which has the plurality of protruding structures 110 to mount the beverage container 30 and a second region 12 mounted with various terminals 40.

At this time, the terminal 40 may include various terminals which are able to be mounted on the multipurpose tray apparatus 1 and have a wireless charging function, such as a smart phone, a portable terminal, a mobile terminal, a personal digital assistant (PDA), a portable multimedia player (PMP), a telematics terminal, a navigation terminal, a notebook computer, a slate PC, a tablet PC, an ultrabook, a wearable device (for example, including a smart watch, a smart glass, a head mounted display (HMD), and the like), a Wibro terminal, an audio video navigation (AVN) terminal, an audio/video (A/V) system, and a flexible terminal.

Accordingly, the electronic device module 300 may be configured to transmit the charging power to the second region 12 of the body 10 through a wireless charging method such as electromagnetic induction based on the electric power supplied from the battery 200, And a charger for providing the data to the terminal 40.

The electronic device module 300 may be configured as a heater for heating the beverage container 30 so that the beverage of the beverage container 30 mounted on the upper surface of the body 10 is maintained at a predetermined temperature.

The electronic device module 300 may include a controller including a RAM, a ROM, a CPU, and a bus, a charging coil for wireless charging, a heating coil for heating, and the like.

In addition, the body 10 may include a user input module for setting an operation of the electronic device module 300. For example, the user input module may include a switch for turning on or off a power supply of the electronic device module 300, a button for inputting a set value such as a temperature to the electronic device module 300, and the like.

Accordingly, the electronic device module 300 may be activated and operated based on a user input by the user input module, and may operate according to the set value.

Through the aforementioned configuration, the multipurpose tray apparatus 1 may be widely used not only as a tray for mounting and carrying beverages but also as various uses such as charging of the terminal 40 mounted on the multipurpose tray apparatus 1 or heating for warming the beverages contained in the beverage container 30 to ensure versatility through use extension as compared with existing trays limited to be used for mounting and carrying the beverage container 30, thereby enhancing the convenience of the user.

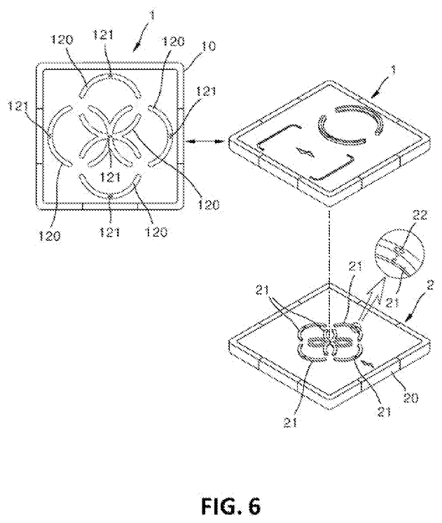

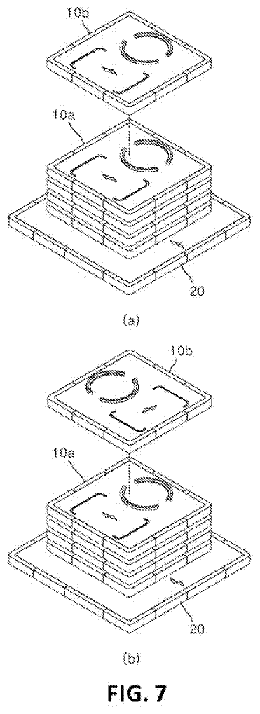

Meanwhile, the multipurpose tray system according to the exemplary embodiment of the present invention may further include a charging station 2 for charging the multipurpose tray apparatus 1 in addition to the multipurpose tray apparatus 1, and will be described in detail with reference to the configuration of FIGS. 6 and 7.

As shown in FIG. 6, the charging station 2 may include a case 20, a plurality of fixing structures 21 which protrude from an upper surface of the case 20 to correspond to the plurality of grooves 120 formed on the body 10, respectively, to be received (or inserted) into the grooves 120 of the body 10 when the body 10 of the multipurpose tray apparatus 1 is stacked on the upper surface of the case 20 and are connected to the charging electrode 121 of the grooves 120 so that the charging terminal 22 providing the charging power to the charging electrode 121 is configured on a part of the upper surface, and a power control module which is configured in the case 20 and provides the charging power to the charging electrode 121 configured in the grooves 120 of the body 10 through the charging terminal 22 based on commercial power provided from the external power source to charge the battery 200 of the multipurpose tray apparatus 1 connected with the charging electrode 121.

At this time, the charging station 2 may further include a power plug to be connected to a socket of the external power source and a power cable to connect the power plug and the power control module, and the power control module is connected to the external power source through the power plug and the power cable to receive commercial power from the external power source.

Through the aforementioned configuration, when the multipurpose tray apparatus 1 is stacked on the charging station 2, a charging electrode 121 formed on the body 10 of the multipurpose tray apparatus 1 and a charging terminal 22 of the charging station 2 are connected to each other, and the power control module may provide the charging power to the battery 200 connected with the charging electrode 122 in the body 10 through the charging electrode 121 connected to the charging terminal 22 to charge the battery 200.

Accordingly, the multipurpose tray apparatus 1 may charge the battery 200 through the charging station 2 when not in use, and provide power to the electronic device module 300 from the battery 200 in use to operate the electronic device module 300.

Meanwhile, as shown in FIG. 7, another multipurpose tray apparatus having the same configuration as that of the multipurpose tray apparatus maybe stacked on the upper surface of the multipurpose tray apparatus 1 stacked on the charging station 2.

Accordingly, when a second body 10b constituting the other multipurpose tray apparatus is stacked on the upper surface of a first body 10a constituting the multipurpose tray apparatus, a protruding structure of the first body 10a is received (or inserted) and fixed to a groove of the second body 10b, and a charging electrode constituted in the groove of the second body 10b and an electrode constituted in the protruding structure of the first body 10a may be connected to each other.

Accordingly, the electronic device module configured in the multipurpose tray apparatus may supply the electric power charged in a first battery configured in the first body 10a to a second battery configured in the second body 10b of the another multipurpose tray apparatus through the charging electrode of the second body 10b connected with the electrode constituted in the protruding structure of the body 10a to charge the second battery.

Through the aforementioned configuration, according to the present invention, when a plurality of different multipurpose tray apparatuses are stacked and stored, a plurality of different multipurpose tray apparatuses may charged simultaneously by transferring the charging power between the plurality of different adjacent multipurpose tray apparatuses. Accordingly, the plurality of different multipurpose tray apparatuses may be stacked on the upper surface of the charging station to easily perform the charging during storage, thereby securing convenience in power management of the multipurpose tray apparatus.

At this time, among the plurality of different multipurpose tray apparatuses stacked and stored, the multipurpose tray apparatus, which is located on the upper surface of the charging station to be connected to the charging station, receives the charging power required for charging the plurality of different multipurpose tray apparatuses from the charging station to charge all of the plurality of different multipurpose tray apparatuses.

Meanwhile, as shown in FIGS. 6 and 7, a plurality of grooves 120 corresponding to the plurality of protruding structures 110 may be formed on a lower surface of the multipurpose tray apparatus 1 to be duplicated to each of the plurality of different regions on the lower surface.

Also, the body 10 of the multipurpose tray apparatus 1 may have a regular polygonal or circular shape.

As a result, in addition to stacking and arranging the plurality of different multipurpose tray apparatuses in the same arrangement state as shown in FIG. 7(a), when the plurality of different multipurpose tray apparatuses 1 are mutually stacked, as shown in FIG. 7B, while the second body 10b of the other multipurpose tray apparatus stacked on the upper surface of the first body 10a of a specific multipurpose tray apparatus is rotated so that at least two of the plurality of grooves 120 constituted in the second body 10b of the another multi-purpose tray apparatus and the plurality of protruding structures 110 constituted in the first body 10a of the specific multipurpose tray apparatus are opposed to each other, the second body 10b of the other multipurpose tray apparatus may be stacked and disposed on the upper surface of the first body 10a of the specific multipurpose tray apparatus so as to have a different arrangement state from the arrangement state of the first body 10a of the specific multipurpose tray apparatus.

At this time, the arrangement state may mean an arrangement direction or an arrangement angle.

Accordingly, even if the multipurpose tray apparatus is stacked and disposed in an arrangement direction or arrangement angle different from that of the other multipurpose tray apparatus, the protruding structure 110 formed in any one of the multipurpose tray apparatuses may be coupled to the groove 120 formed in the other multipurpose tray apparatus.

Further, as shown in FIG. 6, the plurality of fixing structures 21 formed in the charging station 2 maybe configured on the lower surface of the body 10 of the multipurpose tray apparatus 1 to correspond to each of the plurality of grooves 120 which are duplicated to be stacked on the charging station 2 conveniently without considering the arrangement direction and the angle of the multipurpose tray apparatus 1.

That is, the plurality of grooves 120 corresponding to the plurality of protruding structures 110 are formed on the lower surface of the body 10 of the multipurpose tray apparatus 1 to be duplicated to each of the plurality of different regions of the lower surface of the body 10, so that the multipurpose tray apparatus 1 may be rotated in an arbitrary direction to be disposed on the upper portion or the upper surface of the body of the case of the charging station 2 or the other multipurpose tray apparatus.

Accordingly, according to the present invention, the plurality of multipurpose tray apparatuses are able to be easily stacked even if arrangement states between the plurality of different multipurpose tray apparatuses to be stacked and stored without considering the arrangement direction and angle of the multipurpose tray apparatuses, thereby increasing the storage convenience.

Further, the lower surface of the body constituting the multipurpose tray apparatus may have aesthetics through the plurality of grooves formed in the lower surface of the body.

As described above, the multipurpose tray system according to the exemplary embodiment of the present invention provides a charging station capable of stacking and charging the multipurpose tray apparatuses to support the multipurpose tray apparatus to be stacked and stored in any arrangement state while supporting the multipurpose tray apparatuses to be easily charged and stored, thereby increasing the storage convenience.

As described above, it will be understood to those skilled in the art that the present invention can be corrected and modified without departing from the intrinsic features of the present invention. Therefore, the exemplary embodiments disclosed in the present invention are used to not limit but describe the technical spirit of the present invention and the scope of the technical spirit of the present invention is not limited by the exemplary embodiments. The scope of the present invention should be interpreted by the appended claims and it should be analyzed that all technical spirit in the equivalent range thereto is intended to be embraced by the scope of the present invention.

What is claimed is:

1. A multipurpose tray system which includes a charging station supplying charging power and a multipurpose tray apparatus stacked on the charging station to be stored and charged,
Wherein the multipurpose tray apparatus includes
a body having a beverage container mounted on an upper surface thereof;
a plurality of protruding structures protruding from the upper surface of the body to fixedly support the beverage container, separated into at least two or more, and having an electrode formed on at least one side;
a battery configured in the body to supply electric power to the electrode;
an electronic device module configured in the body to operate based on the electric power supplied from the battery; and
a plurality of grooves which is formed on the lower of the body, has a shape corresponding to each of the plurality of protruding structures, and has a charge electrode corresponding to the electrode.

2. The multipurpose tray system of claim 1, wherein the body has a regular polygonal or circular shape.

3. The multipurpose tray system of claim 1, wherein each of the plurality of protruding structures has an inclined portion formed at one side to discharge water droplets of the beverage container so as not to contact the electrode when the water droplets of the beverage container flow down.

4. The multipurpose tray system of claim 1, wherein the electrode is formed on a part of the upper surface of the protruding structures.

5. The multipurpose tray system of claim 1, wherein the electronic device module is configured as a heater for heating the beverage container so that the beverage of the beverage container mounted on the upper surface of the body is maintained at a predetermined temperature.

6. The multipurpose tray system of claim 1, wherein the electronic device module is configured by a wireless charging module that provides charging power to the communication device mounted on the upper surface of the body in a wireless charging manner based on the electric power supplied from the battery.

7. The multipurpose tray system of claim 1, wherein the charging station includes
a case;
a plurality of fixing structures which protrude from an upper surface of the case to correspond to the plurality of grooves formed on the body, respectively, to be received into the grooves of the body when the body of the multipurpose tray apparatus is stacked on the upper surface of the case and are connected to the charging electrode of the grooves so that the charging terminal providing the charging power to the charging electrode is configured on a part of the upper surface, and
a power control module which provides the charging power to the charging electrode configured in the grooves of the body through the charging terminal based on commercial power provided from the external power source to charge the battery of the multipurpose tray apparatus connected with the charging electrode.

8. The multipurpose tray system of claim 7, wherein a plurality of grooves corresponding to the plurality of protruding structures are formed on a lower surface of the multipurpose tray apparatus to be duplicated to each of the plurality of different regions on the lower surface, so that the multipurpose tray apparatus is rotated in an arbitrary direction to be disposed on the upper surface of the body of the case of the charging station or the other multipurpose tray apparatus.

9. The multipurpose tray system of claim 1, wherein the protruding structure has an elliptical shape.

10. A multipurpose tray apparatus comprising:
a body having a beverage container mounted on an upper surface thereof;
a plurality of protruding structures protruding from the upper surface of the body to fixedly support the beverage container, separated into at least two or more, and having an electrode formed on at least one side;
a battery configured in the body to supply electric power to the electrode;
an electronic device module configured in the body to operate based on the electric power supplied from the battery; and
a plurality of grooves which are formed on the lower surface of the body, have a shape corresponding to each of the plurality of protruding structures, and have a charge electrode corresponding to the electrode.
